(19) United States
(12) Patent Application Publication
(10) Pub. No.: US 2026/0349440 A1
(43) Pub. Date: Nov. 5, 2026

(54) Method for Controlling Self-Moving Device, Self-Moving Device and Computer-Readable Medium

(71) Applicant: JIANGSU DONGCHENG M & E TOOLS CO., LTD., Nantong (CN)

(72) Inventor: Wubin ZHEN, Nantong (CN)

(73) Assignee: JIANGSU DONGCHENG M & E TOOLS CO., LTD., Nantong, JS (CN)

(21) Appl. No.: 19/117,978

(22) PCT Filed: Aug. 26, 2024
(86) PCT No.: PCT/CN2024/114466

§ 371 Date: Apr. 3, 2025

(30) Foreign Application Priority Data
Sep. 26, 2023 (CN) 202311262898.5

(51) Int. Cl. G05D 1/648; A01D 34/00; A01D 101/00; G05D 107/20; G05D 109/10

(52) U.S. Cl. CPC G05D 1/6484; A01D 34/008; A01D 2101/00; G05D 2107/23; G05D 2109/10

(57) ABSTRACT

The present invention provides a method for controlling a self-moving device, the self-moving device, and a computer-readable media. The method includes: identifying a narrow passage in a cost map; determining whether the identified narrow passage is an extremely narrow passage; for extremely narrow passages, employing a bidirectional edge-following cutting strategy for coverage cutting; for non-extremely narrow passages, using a zigzag coverage strategy for coverage cutting. The invention adopts different coverage planning strategies for different types of narrow passages, taking into account not only the self-moving device's ability to navigate through narrow passages but also the edge cutting coverage and internal cutting coverage. This addresses the coverage planning issues when the self-moving device is cutting in narrow passages.

### CROSS-REFERENCE TO RELATED APPLICATIONS

This application is a 35 U.S.C. § 371 National Phase conversion of International (PCT) Patent Application No. PCT/CN2024/114466, filed on Aug. 26, 2024, which is based upon and claims the priority to Chinese Patent Application No. 202311262898.5, filed on Sep. 26, 2023. The entire contents of the above-identified applications are incorporated herein by reference.

### TECHNICAL FIELD

The present invention relates to the field of coverage planning technology for self-moving devices, particularly to a method for controlling a self-moving device, a self-moving device and a computer-readable medium.

### BACKGROUND

Self-moving devices, such as lawn mowers, can assist people in completing the trimming of large areas of lawn, maintaining vegetation conditions, thereby reducing manual labor and saving human resources. Lawns are laid out according to specific terrains and are usually irregular in shape, necessitating the division of mowing areas.

When self-moving devices perform zigzag coverage cutting, a certain width of area is required. When there are narrow passages within the divided areas, it is difficult for the self-moving devices to plan in zigzag, and special strategies are needed to complete the coverage cutting of the narrow passages.

In existing technologies regarding narrow passages, some only consider the passage through the narrow path without considering the coverage cutting issue, while others only consider the edge cutting coverage and neglect the planning of internal coverage of the narrow passages. Therefore, it is difficult to meet the coverage planning requirements of self-moving devices in narrow passages.

### SUMMARY OF THE DISCLOSURE

In view of the above-mentioned problems, the objective of the present invention is to provide a method for controlling a self-moving device, the self-moving device and a computer-readable medium, in order to resolve the coverage planning issues when self-moving devices are cutting in narrow passages.

To solve the above technical problems, the present invention provides the following technical solution:

On one hand, a method for controlling a self-moving device is provided, which includes the following steps:
when the self-moving device operates in an extremely narrow passage, the self-moving device employs a bidirectional edge-following cutting strategy for coverage cutting;
when the self-moving device operates in a non-extremely narrow passage, the self-moving device employs a planned coverage cutting strategy for coverage cutting.

Preferably, the method further includes: obtaining a narrow passage and determining whether the narrow passage is the extremely narrow passage, which specifically includes:

If the width Ymin of the narrow passage is less than or equal to A*P, then the narrow passage is the extremely narrow passage; if Ymin is greater than A*P, then the narrow passage is the non-extremely narrow passage; wherein A is a value within a range [0.5-2], wherein P is a body width of the self-moving device.

Preferably, wherein the planned coverage cutting strategy including a zigzag coverage strategy.

Preferably, the method further includes:

If the width Ymin of the narrow passage is less than or equal to min(P,Q), then the narrow passage is considered the extremely narrow passage; if Ymin is greater than min(P,Q), then the narrow passage is considered the non-extremely narrow passage, wherein P is a body width of the self-moving device and Q is the width required for zigzag turning.

Preferably, the method further includes:

If the width Ymin of the narrow passage is less than or equal to X, then the narrow passage is considered the extremely narrow passage; if Ymin is greater than X, then the narrow passage is considered the non-extremely narrow passage; wherein X is a value within a range of 20 cm-150 cm.

Preferably, the method further includes:
when the self-moving device moves from area A to area B through the extremely narrow passage, the self-moving device travels along a route at a first fixed distance from one side of the extremely narrow passage to reach area B; and/or
when the self-moving device moves from area B to area A through the extremely narrow passage, the self-moving device travels along a route at a second fixed distance from the other side of the extremely narrow passage to reach area A, wherein area A and area B are connected by a extremely narrow passage.

Preferably, the first fixed distance and the second fixed distance are the same or different, and the first fixed distance and the second fixed distance are within the range of 10 cm-50 cm.

Preferably, setting the body width of the self-moving device as P; when the self-moving device passes through the extremely narrow passage, the distance of the self-moving device from the edge of the extremely narrow passage is greater than or equal to B*P, wherein B is a value within a range [0.2-0.6], and P is a body width of the self-moving device.

On the other hand, a self-moving device is provided, which includes a memory, a processor, the memory storing a computer program that can be executed by the processor, and when the processor executes the computer program, it implements the following steps:
when the self-moving device operates in an extremely narrow passage, the self-moving device employs a bidirectional edge-following cutting strategy for coverage cutting, when the self-moving device operates in a non-extremely narrow passage, the self-moving device employs a planned coverage cutting strategy for the coverage cutting.

Preferably, the method further includes: obtaining a narrow passage and determining whether the narrow passage is the extremely narrow passage, which specifically includes:
when the width Ymin of the narrow passage is less than or equal to A*P, then the narrow passage is the extremely narrow passage; when Ymin is greater than A*P, then the narrow passage is the non-extremely narrow passage; wherein A is a value within a range [0.5-2], wherein P is a body width of the self-moving device.

Preferably, wherein the planned coverage cutting strategy including a zigzag coverage strategy; the method further includes:

If the width Ymin of the narrow passage is less than or equal to min(P,Q), then the narrow passage is considered the extremely narrow passage; if Ymin is greater than min(P,Q), then the narrow passage is considered the non-extremely narrow passage, wherein P is a body width of the self-moving device and Q is the width required for zigzag turning.

Preferably, the method further includes:

If the width Ymin of the narrow passage is less than or equal to X, then the narrow passage is considered the extremely narrow passage; if Ymin is greater than X, then the narrow passage is considered the non-extremely narrow passage; wherein X is a value within a range of 20 cm-150 cm.

Preferably, the method further includes:
when the self-moving device moves from area A to area B through the extremely narrow passage, the self-moving device travels along a route at a first fixed distance from one edge of the extremely narrow passage to reach area B; and/or
when the self-moving device moves from area B to area A through the extremely narrow passage, the self-moving device travels along a route at a second fixed distance from an other edge of the extremely narrow passage to reach area A, wherein area A and area B are connected by a extremely narrow passage.

Preferably, when the self-moving device passes through the extremely narrow passage, a distance of the self-moving device from the edge of the extremely narrow passage is greater than or equal to B*P, wherein B is a value within a range [0.2-0.6], and P is a body width of the self-moving device.

On the other hand, a computer-readable medium is provided, which includes non-volatile program code executable by a processor, and the program code causes the processor to execute implements following steps:
when the self-moving device operates in an extremely narrow passage, the self-moving device employs a bidirectional edge-following cutting strategy for coverage cutting;
when the self-moving device operates in a non-extremely narrow passage, the self-moving device employs a planned coverage cutting strategy for the coverage cutting.

Preferably, the method further includes: obtaining a narrow passage and determining whether the narrow passage is the extremely narrow passage, which specifically includes:
when the width Ymin of the narrow passage is less than or equal to A*P, then the narrow passage is the extremely narrow passage; when Ymin is greater than A*P, then the narrow passage is the non-extremely narrow passage; wherein A is a value within a range [0.5-2], wherein P is a body width of the self-moving device.

Preferably, wherein the planned coverage cutting strategy including a zigzag coverage strategy; the method further includes:

If the width Ymin of the narrow passage is less than or equal to min(P,Q), then the narrow passage is considered the extremely narrow passage; if Ymin is greater than min(P,Q), then the narrow passage is considered the non-extremely narrow passage, wherein P is a body width of the self-moving device and Q is the width required for zigzag turning.

Preferably, the method further includes:

If the width Ymin of the narrow passage is less than or equal to X, then the narrow passage is considered the extremely narrow passage; if Ymin is greater than X, then the narrow passage is considered the non-extremely narrow passage; wherein X is a value within a range of 20 cm-150 cm.

Preferably, the method further includes:
when the self-moving device moves from area A to area B through the extremely narrow passage, the self-moving device travels along a route at a first fixed distance from one edge of the extremely narrow passage to reach area B; and/or
when the self-moving device moves from area B to area A through the extremely narrow passage, the self-moving device travels along a route at a second fixed distance from an other edge of the extremely narrow passage to reach area A; wherein area A and area B are connected by a extremely narrow passage.

Preferably, setting the body width of the self-moving device as P; when the self-moving device passes through the extremely narrow passage, a distance of the self-moving device from an edge of the extremely narrow passage is greater than or equal to B*P, wherein B is a value within a range [0.2-0.6], and P is a body width of the self-moving device.

Compared to the existing technology, the technical solution provided by the present invention has the following beneficial effects:

The method for controlling the self-moving device, the self-moving device, and the computer-readable medium provided by the present invention, first identifies a narrow passage in a cost map; then determines whether the identified narrow passages is an extremely narrow passage; for the extremely narrow passage, a bidirectional edge-following cutting strategy is adopted for coverage cutting; for a non-extremely narrow passages, a zigzag coverage strategy is adopted for coverage cutting. The invention adopts different coverage planning strategies for different types of narrow passages, taking into account not only the self-moving device's ability to pass through narrow passages but also the edge cutting coverage and internal cutting coverage. This addresses the coverage planning issues when self-moving devices are cutting in narrow passages.

### BRIEF DESCRIPTION OF THE DRAWINGS

To more clearly explain the technical solutions of the embodiments of the present invention, a brief introduction will be provided for the drawings that are necessary for the description of the embodiments. It is apparent that the drawings described below are merely some examples of the present invention. For ordinary skilled personnel in the field, other drawings can be obtained based on these without the expenditure of inventive effort.

FIG. 1 is a flowchart of a coverage planning method for a narrow passage of a self-moving device provided by an embodiment of the present invention;

FIG. 2 is a schematic diagram for identifying the position and width of the narrow passage provided by an embodiment of the present invention;

FIG. 3 is a schematic diagram of a coverage planning scenario for an extremely narrow passage provided by an embodiment of the present invention;

FIG. 4 is a schematic diagram of a coverage planning scenario for a non-extremely narrow passage provided by an embodiment of the present invention;

FIG. 5 is a structural diagram of a coverage planning system for a narrow passage of a self-moving device provided by an embodiment of the present invention.

### DETAILED DESCRIPTION OF PREFERRED EMBODIMENTS

To make the purposes, technical solutions, and advantages of the embodiments of the present invention more clear, the following will provide a clear and complete description of the technical solutions of the embodiments of the present invention in conjunction with the drawings. Obviously, the embodiments described below are only some of the embodiments of the present invention, not all of them. Based on the embodiments of the present invention described, all other embodiments obtained by a person ordinary skilled in the art without the need for inventive effort fall within the scope of protection of the present invention.

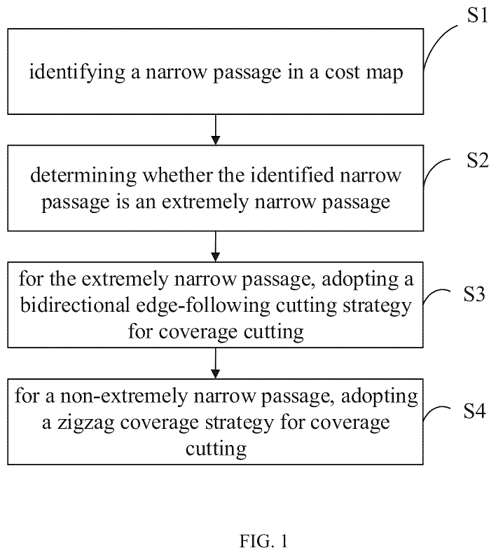

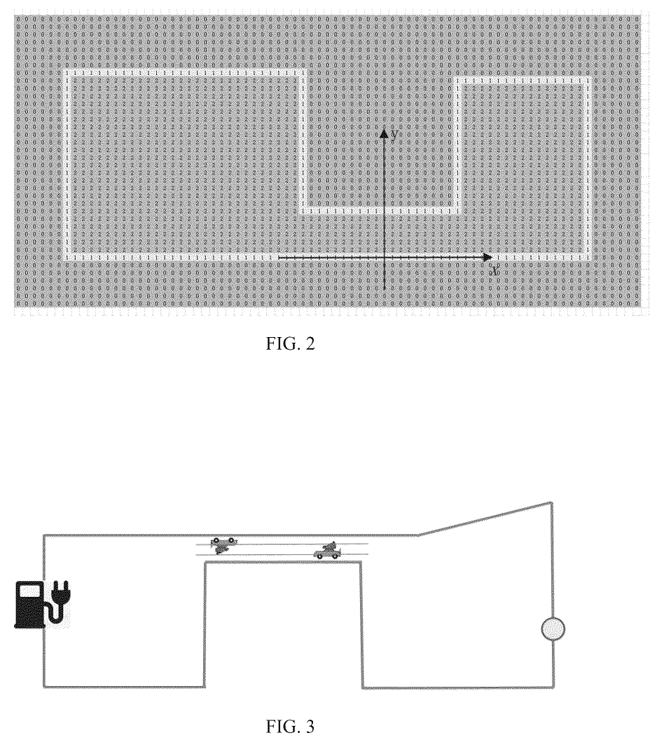

The embodiments of the present invention provide a method for coverage planning of narrow passages of a self-moving device, as shown in FIG. 1, the method includes the following steps:
S1, identifying a narrow passage in a cost map. As shown in FIG. 2, this step specifically includes:
S11, the entire cost map includes three parts: boundary points with a first identifier, internal areas with a second identifier, i.e., areas inside the boundary, and external areas with a third identifier, i.e., areas outside the boundary; preferably, the entire cost map is divided into the following three parts: boundaries with a value of 1 (composed of boundary points with a value of 1), internal areas with a value of 2, and external areas with a value of 0;
S12, traversing the entire cost map, for boundary points with the first identifier, if a counterclockwise boundary point with a value of 1 is found, store it in an array;
S13, using the boundary point as the origin and the preset boundary direction as the positive direction of the x-axis to establish a local coordinate system; preferably, traverse the counterclockwise boundary, and each time use the counterclockwise boundary point as the origin, with the counterclockwise boundary direction as the positive direction of the x-axis to establish the local coordinate system; in other embodiments, a local coordinate system can also be established based on the clockwise boundary point using the same method.
S14, in the local coordinate system, fixing the value of x-coordinate and start the value of y-coordinate from 0 up to a preset value M to conduct a search incrementally; if a boundary point with the first identifier is encountered, record the boundary point that is serving as the origin and terminate the search in the y-direction; in a specific implementation, search for points in the local coordinate system where the value of the x-coordinate is 0 and the value of the y-coordinate starting from 0 up to the preset value M; if a boundary point with a value of 1 is found, record the boundary point that is serving as the origin and terminate the search in the y-direction; if the preset value M is reached without encountering a boundary point with a value of 1, end the search, considering that the boundary point serving as the origin is not within a narrow passage.
S15, if more than a preset number of boundary points are recorded consecutively, the area between the recorded boundary points and the encountered boundary points is identified as a narrow passage. In a preferred embodiment, if more than a preset number of boundary points are recorded consecutively, area enclosed by the recorded boundary points and the encountered boundary points is identified as a narrow passage, and the width of this narrow passage is the smallest value of the y-coordinate Ymin among the encountered boundary points.

As an optional implementation, the preset value M typically is a value of 20, i.e.: search for points in the local coordinate system where the value of the x-coordinate is 0, and the value of the y-coordinate starting from 0 to the preset value 20 and increasing sequentially; if the preset value 20 is reached without encountering a boundary point with a value of 1, it is considered that the boundary point as the origin is not in a narrow passage.

As an optional implementation, the preset number is 10, i.e.: if more than 10 boundary points are recorded consecutively, area between the recorded boundary points and the encountered boundary points is a narrow passage.
S2, determining whether the identified narrow passage is an extremely narrow passage.

In one embodiment of this step, set a body width of the self-moving device as P;

By searching for boundary points, if the width Ymin of the narrow passage is less than or equal to A*P, then the narrow passage is an extremely narrow passage; if Ymin is greater than A*P, then the narrow passage is a non-extremely narrow passage; wherein A is a value between [0.5-2], and the specific value can be set according to the actual working conditions or scenarios.

In another embodiment of this step, set the body width of the self-moving device as P, and the width required for zigzag turning as Q;

If the smallest value of the y-coordinate Ymin of the searched boundary points is less than or equal to min(P,Q), then the current narrow passage is judged to be an extremely narrow passage; if Ymin is greater than min(P,Q), then the current narrow passage is judged to be a non-extremely narrow passage.

In another embodiment of this step, a fixed value can also be set directly based on the minimum width of the passage and user needs, i.e., if the width Ymin of the narrow passage is less than or equal to X, then the narrow passage is an extremely narrow passage; if Ymin is greater than X, then the narrow passage is a non-extremely narrow passage; wherein X is a value between 20 cm-150 cm, for example, X can be 20 cm, 30 cm, 40 cm, 50 cm, 60 cm, 70 cm, 80 cm, 90 cm, 100 cm, 110 cm, 120 cm, 130 cm, 140 cm, etc., or any other value between 20-150.
S3, for the extremely narrow passage, adopting a bidirectional edge-following cutting strategy for coverage cutting.

As shown in FIG. 3, for extremely narrow passages, set one side of the extremely narrow passage as area A, and the other side as area B, when the self-moving device moves from area A to area B through the extremely narrow passage, the self-moving device travel along a route at a first fixed distance from one side of the extremely narrow passage to reach area B; and/or
when the self-moving device moves from area B to area A through the extremely narrow passage, the self-moving device travel along a route at a second fixed distance from the other side of the extremely narrow passage to reach area A. The first fixed distance and the second fixed distance can be the same or different, and are specifically set according to actual needs.

Preferably, the bidirectional edge-following cutting strategy includes:
S31, when transitioning from area A to area B via the extremely narrow passage after completing the cutting in area A, activate the cutting motor of the self-moving device to engage its working state. The self-moving device travel from area A to area B along a route that is one-quarter of the vehicle's width inward from the right side edge of the vehicle's front within the extremely narrow passage; similarly, when moving from area A to area B, the self-moving device can also traverse along a preset distance from the left side edge of the vehicle's front within the extremely narrow passage.
S32, after cutting is completed in Area B, similarly turn on the cutting motor of the self-moving device to make it operational, and travel from area B along the edge of the extremely narrow passage, a quarter of the vehicle width inward from the right side of the vehicle's front, to reach Area A, thus completing the coverage planning of the extremely narrow passage. Similarly, when moving from area B to area A, the self-moving device can also traverse along a preset a distance from the left side edge of the vehicle's front in the extremely narrow passage.
S4, for a non-extremely narrow passage, adopting a zigzag coverage strategy for coverage cutting.

In other embodiments of the above steps, other values can also be set according to the vehicle width to allow the self-moving device to pass through the extremely narrow passage based on the set values; specifically, set the body width of the self-moving device as P; when the self-moving device passes through the extremely narrow passage, the distance from the right side of the vehicle's front to the edge of the extremely narrow passage is greater than or equal to B*P, wherein B is a value between [0.2-0.6]; thus ensuring precise control of the cutting.

In other embodiments of the above steps, for the extremely narrow passage, set one side of the extremely narrow passage as area A, and the other side as area B; the method also includes: when the self-moving device moves from area A to area B through the extremely narrow passage, travel along a route at a first fixed distance from one edge of the extremely narrow passage to reach area B; and/or when the self-moving device moves from area B to area A through the extremely narrow passage, travel along a route at a second fixed distance from an other edge of the extremely narrow passage to reach area A. The first fixed distance and the second fixed distance are the same or different, and the first fixed distance and the second fixed distance are within the range of 10 cm-50 cm.

As shown in FIG. 4, for non-extremely narrow passages, the zigzag coverage strategy includes:
S41, integrating the non-extremely narrow passage into the entire cost map for division;
S42, based on the division result, performing zigzag coverage planning for a sub-area where the non-extremely narrow passage is located;
S43, the self-moving device cutting the non-extremely narrow passage based on the zigzag coverage plan of the sub-area where the self-moving is located.

In the embodiments of the present invention, narrow passages are first identified in the cost map; then it is determined whether the identified narrow passages are extremely narrow passages; for extremely narrow passages, a bidirectional edge-following cutting strategy is adopted for coverage cutting; for non-extremely narrow passages, a zigzag coverage strategy is adopted for coverage cutting. The invention adopts different coverage planning strategies for different types of narrow passages, considering not only the self-moving device's passage through the narrow passages but also the edge and internal cutting coverage, thus solving the coverage planning problem when the self-moving device cuts in narrow passages.

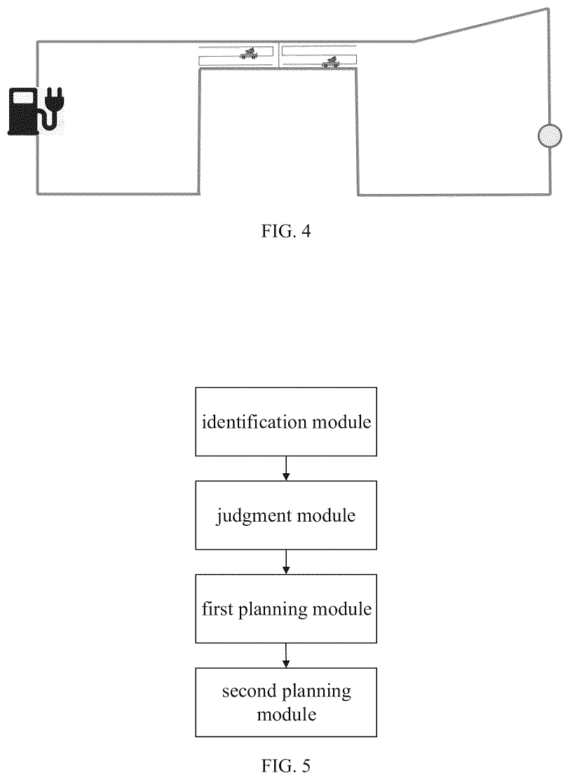

Accordingly, the embodiments of the present invention also provide a system for coverage planning of narrow passages of a self-moving device, as shown in FIG. 5, the system includes:
an identification module, configured to identify a narrow passage in a cost map,
a judgment module, configured to determine whether the identified narrow passage is an extremely narrow passage;
a first planning module, configured to adopt a bidirectional edge-following cutting strategy for coverage cutting of the extremely narrow passage;
a second planning module, configured to adopt a zigzag coverage strategy for coverage cutting of a non-extremely narrow passage.

The system of this embodiment can be used to implement the technical solution of the method embodiment shown in FIG. 1, and its implementation principle and technical effects are similar, which will not be repeated here.

The embodiments of the present invention also provide an electronic device, that is, a self-moving device, which can vary greatly due to different configurations or performances, and can include one or more processors (central processing units, CPUs) and one or more memories, wherein the memory stores at least one instruction, and the at least one instruction is loaded and executed by the processor to implement the steps of the above method for coverage planning of narrow passages of the self-moving device.

In an exemplary embodiment, a computer-readable storage medium is also provided, such as a memory including instructions, the above instructions can be executed by a processor in a terminal to complete the method for coverage planning of narrow passages of the self-moving device. For example, the computer-readable storage medium can be ROM, random access memory (RAM), CD-ROM, magnetic tape, floppy disk, and optical data storage devices, etc.

It should be noted that in this text, the terms “comprising,” “including,” or any of their variants are intended to encompass non-exclusive inclusion, so that a process, method, article, or apparatus that includes a series of elements includes not only those elements but also other elements that are not explicitly listed, or also includes elements inherent in the process, method, article, or apparatus. Unless further limited, an element limited by the phrase “comprising a . . . ” does not preclude the presence of additional identical elements in the process, method, article, or apparatus that includes the described element.

In the specification, the phrases “an embodiment,” “embodiments,” “example embodiment,” “some embodiments,” etc., indicate that the described embodiments may include specific features, structures, or characteristics, but not every embodiment includes that specific feature, structure, or characteristic. Moreover, when describing specific features, structures, or characteristics in conjunction with embodiments, the implementation of such features, structures, or characteristics in conjunction with other embodiments (whether or not explicitly described) should be within the knowledge of those skilled in the relevant field.

The present invention encompasses any substitutions, modifications, equivalent methods, and schemes made within the spirit and scope of the present invention. To give the public a thorough understanding of the present invention, the following preferred embodiments of the present invention provide detailed descriptions of specific details, which can be fully understood by those skilled in the art without the need for these descriptions. Moreover, to avoid unnecessary confusion about the essence of the present invention, well-known methods, processes, procedures, components, and circuits are not described in detail.

It is understood by those skilled in the art that all or part of the steps of the methods of the embodiments described above can be implemented by instructing related hardware through a program, which can be stored in a computer-readable storage medium, such as ROM/RAM, disks, optical discs, etc. The foregoing is merely the preferred embodiments of the present invention and is not intended to limit the present invention.

Any modifications, equivalent substitutions, improvements, etc., made within the spirit and principles of the present invention, should be included within the scope of protection of the present invention.

1. A method for controlling a self-moving device, characterized in that, the method comprises following steps:
when the self-moving device operates in an extremely narrow passage, the self-moving device employs a bidirectional edge-following cutting strategy for coverage cutting;
when the self-moving device operates in a non-extremely narrow passage, the self-moving device employs a planned coverage cutting strategy for coverage cutting.

2. The control method according to claim 1, characterized in that, the method further comprises: obtaining a narrow passage and determining whether the narrow passage is the extremely narrow passage, which specifically comprises:
when the minimum width Ymin of the narrow passage is less than or equal to A*P, then the narrow passage is the extremely narrow passage; when Ymin is greater than A *P, then the narrow passage is the non-extremely narrow passage; wherein A is a value within a range [0.5-2], wherein P is a body width of the self-moving device.

3. The control method according to claim 1, characterized in that, wherein the planned coverage cutting strategy comprises a zigzag coverage strategy.

4. The control method according to claim 3, characterized in that, method further comprises:
when the minimum width Ymin of the narrow passage is less than or equal to min(P,Q), then the narrow passage is the extremely narrow passage; when Ymin is greater than min(P,Q), then the narrow passage is the non-extremely narrow passage, wherein P is a body width of the self-moving device and Q is the width required for zigzag turning.

5. The control method according to claim 1, characterized in that, the method further comprises:
when the minimum width Ymin of the narrow passage is less than or equal to X, then the narrow passage is the extremely narrow passage; when Ymin is greater than X, then the narrow passage is the non-extremely narrow passage; wherein X is a value within a range of 20 cm-150 cm.

6. The control method according to claim 1, characterized in that, the method further comprises:
when the self-moving device moves from area A to area B through the extremely narrow passage, the self-moving device travels along a route at a first fixed distance from one edge of the extremely narrow passage to reach area B; and/or
when the self-moving device moves from area B to area A through the extremely narrow passage, the self-moving device travels along a route at a second fixed distance from an other edge of the extremely narrow passage to reach area A;
wherein area A and area B are connected by a extremely narrow passage.

7. The control method according to claim 6, characterized in that, the first fixed distance and the second fixed distance are the same or different, and the first fixed distance and the second fixed distance are values within a range of 10 cm-50 cm.

8. The control method according to claim 6, characterized in that, when the self-moving device passes through the extremely narrow passage, a distance of the self-moving device from the edge of the extremely narrow passage is greater than or equal to B*P, wherein B is a value within a range [0.2-0.6], and P is a body width of the self-moving device.

9. A self-moving device, comprising a memory, a processor, the memory storing a computer program that can be executed by the processor, characterized in that, when the processor executes the computer program, the self-moving device implements the control method described in claim 1.

10. A computer-readable medium, having non-volatile program code executable by a processor, characterized in that, the program code causes the processor to execute the control method described in claim 1.

11. The self-moving device according to claim 9, characterized in that, the method further comprises: obtaining a narrow passage and determining whether the narrow passage is the extremely narrow passage, which specifically comprises:
when the minimum width Ymin of the narrow passage is less than or equal to A*P, then the narrow passage is the extremely narrow passage; when Ymin is greater than A*P, then the narrow passage is the non-extremely narrow passage; wherein A is a value within a range [0.5-2], wherein P is a body width of the self-moving device.

12. The self-moving device according to claim 9, characterized in that, the method further comprises: wherein the planned coverage cutting strategy comprises a zigzag coverage strategy;
the method further comprises:
when the minimum width Ymin of the narrow passage is less than or equal to min(P,Q), then the narrow passage is the extremely narrow passage; when Ymin is greater than min(P,Q), then the narrow passage is the non-extremely narrow passage, wherein P is a body width of the self-moving device and Q is the width required for zigzag turning.

13. The self-moving device according to claim 9, characterized in that, the method further comprises:
when the minimum width Ymin of the narrow passage is less than or equal to X, then the narrow passage is the extremely narrow passage; when Ymin is greater than X, then the narrow passage is the non-extremely narrow passage; wherein X is a value within a range of 20 cm-150 cm.

14. The self-moving device according to claim 9, characterized in that, the method further comprises:
when the self-moving device moves from area A to area B through the extremely narrow passage, the self-moving device travels along a route at a first fixed distance from one edge of the extremely narrow passage to reach area B; and/or
when the self-moving device moves from area B to area A through the extremely narrow passage, the self-moving device travels along a route at a second fixed distance from an other edge of the extremely narrow passage to reach area A;
wherein area A and area B are connected by a extremely narrow passage.

15. The self-moving device according to claim 14, characterized in that, when the self-moving device passes through the extremely narrow passage, a distance of the self-moving device from the edge of the extremely narrow passage is greater than or equal to B*P, wherein B is a value within a range [0.2-0.6], and P is a body width of the self-moving device.

16. The computer-readable medium according to claim 10, characterized in that, the method further comprises: obtaining a narrow passage and determining whether the narrow passage is the extremely narrow passage, which specifically comprises:
when the minimum width Ymin of the narrow passage is less than or equal to A*P, then the narrow passage is the extremely narrow passage; when Ymin is greater than A*P, then the narrow passage is the non-extremely narrow passage; wherein A is a value within a range [0.5-2], wherein P is a body width of the self-moving device.

17. The computer-readable medium according to claim 10, characterized in that, the method further comprises: wherein the planned coverage cutting strategy comprises a zigzag coverage strategy;
the method further comprises:
when the minimum width Ymin of the narrow passage is less than or equal to min(P,Q), then the narrow passage is the extremely narrow passage; when Ymin is greater than min(P,Q), then the narrow passage is the non-extremely narrow passage, wherein P is a body width of the self-moving device and Q is the width required for zigzag turning.

18. The computer-readable medium according to claim 10, characterized in that, the method further comprises:
when the minimum width Ymin of the narrow passage is less than or equal to X, then the narrow passage is the extremely narrow passage; when Ymin is greater than X, then the narrow passage is the non-extremely narrow passage; wherein X is a value within a range of 20 cm-150 cm.

19. The computer-readable medium according to claim 10, characterized in that, the method further comprises:
when the self-moving device moves from area A to area B through the extremely narrow passage, the self-moving device travels along a route at a first fixed distance from one edge of the extremely narrow passage to reach area B; and/or
when the self-moving device moves from area B to area A through the extremely narrow passage, the self-moving device travels along a route at a second fixed distance from an other edge of the extremely narrow passage to reach area A;
wherein area A and area B are connected by a extremely narrow passage.

20. The computer-readable medium according to claim 19, characterized in that, when the self-moving device passes through the extremely narrow passage, a distance of the self-moving device from the edge of the extremely narrow passage is greater than or equal to B*P, wherein B is a value within a range [0.2-0.6], and P is a body width of the self-moving device.
